(19) United States
(12) Patent Application Publication
(10) Pub. No.: US 2024/0190073 A1
(43) Pub. Date: Jun. 13, 2024

(54) APPARATUS FOR ADDITIVE MANUFACTURE OF MANUFACTURING PRODUCTS

(71) Applicant: EOS GmbH Electro Optical Systems, Krailling (DE)

(72) Inventor: Julia Schmidt-Petersen, Grafrath (DE)

(73) Assignee: EOS GmbH Electro Optical Systems, Krailling (DE)

(21) Appl. No.: 18/282,866

(22) PCT Filed: Mar. 11, 2022
(86) PCT No.: PCT/EP2022/056380

§ 371 Date: Sep. 19, 2023

(30) Foreign Application Priority Data
Mar. 23, 2021 (DE) 10 2021 107 265.4

(51) Int. Cl. B29C 64/307; B29C 64/153; B29C 64/245; B33Y 10/00; B33Y 30/00; B33Y 40/00

(52) U.S. Cl. CPC B29C 64/307; B29C 64/153; B29C 64/245; B33Y 10/00; B33Y 30/00; B33Y 40/00

(57) ABSTRACT

Disclosed is an additive manufacturing apparatus. The apparatus includes a residual powder chamber with a receiving opening to receive excess powdered material. A region between the construction area and the receiving opening has at least one flow restricting device. A region between a construction area of the apparatus and the residual powder chamber and/or at least a part of the residual powder chamber is preferably covered by at least one cover element leaving the receiving opening free. The surface of the cover element least one flow restricting device for the powdered construction material.

The invention relates to an apparatus for the additive manufacture of manufacturing products, as well as to a method for the manufacture of such an apparatus. Furthermore, the invention relates to a cover element for use in such an apparatus for the additive manufacture of manufacturing products, as well as to a method for the manufacture and the use of such a cover element and to a method for the additive manufacture of manufacturing products in such an apparatus.

Additive manufacture describes a process in which additive manufacturing products or components (hereinafter also termed objects) are manufactured directly or indi-rectly on the basis of digital 3D construction data, for example from amorphous, in particular powdered, construction materials. A synonym for additive manufacture which is therefore often used is the term “3D printing”.

An essential characteristic of additive manufacturing is the selective, i.e. localised, in particular layered, consolidation of at least one construction material. If the construction material is in the powder form, it is usually initially applied in the form of a thin layer, for example onto a construction platform, or more concisely a build platform, in a processing area or processing chamber of an apparatus for the additive manufacture of manufacturing products.

By means of locally applied radiant energy—as a rule, by means of a laser beam—the powdered particles of the construction material are partially or completely melted or partially or completely sintered in prespecified regions of the layer and then cooled sufficiently for them to bind together to form a solid body. The region of the layer in which the actual consolidation of the construction material occurs is also termed the “consolidation region”. Instead of introducing radiant energy, a consolidation of the construction material may also be carried out with other physical or chemical methods, for example by applying a binder.

Two commercially important methods in which the consolidation of the construction material is carried out by irradiation with radiant energy are “selective laser sintering” (SLS) and “selective laser melting” (SLM).

The irradiation of the layer of powdered construction material here is—as mentioned above—carried out on the basis of prespecifiable 3D construction data for the component to be manufactured, so that only those regions of the layer which are to form an integral part of the component to be manufactured are irradiated. In order to manufacture a complete component, then, thin layers of the powdered construction material are repeatedly applied in the processing area and selectively consolidated, whereupon the individual consolidated layers of the component bind together to form an integral component.

After completion of the selective consolidation of the construction material in a specific layer, the build platform is moved downwards by one layer thickness so that the surface of the selectively consolidated layer with the surrounding area once again forms a plane. Next, a coater applies a further layer of construction material to the preceding lower layer. In doing so, the coater displaces the powdered construction material to form a flat area. In this manner, the powdered construction material again forms a substantially flat working area.

While coating and during the displacement of the powdered construction material to form a working plane, more and more powdered construction material is displaced over the outer boundaries or edge of the working plane. This powder which is displaced over the working plane, hereinafter termed residual powder, is then collected in one or more overflows or residual powder chambers which are disposed to the side of the working plane in the direction of displacement of the coater next to the region of the build platform. Especially when large components are manufactured, a large amount of residual powder is often collected in the residual powder chambers. This is because for each layer of the component to be manufactured, one layer of construction material is applied by the coater to the working plane which in turn, during coating, is displaced into the residual powder chambers in not inconsiderable quantities. In doing so, so much residual powder is often generated that the residual powder chamber(s) are already completely full before the object can be completely manufactured. The build process then has to be interrupted and the residual powder chambers have to be emptied. In this regard, the powder in the residual powder chambers has to be removed from the full residual powder chambers and cleaned (for example screened) in a complicated process before the powder can be used again for the additive manufacture of an object. This results in an expensive and protracted manufacturing process.

An objective of the present invention is to provide an improved apparatus and an improved method for the additive manufacture of manufacturing products, wherein preferably, the consumption of powder can be reduced.

This objective is achieved by an apparatus in accordance with patent claim 1 and a cover element in accordance with patent claim 13, as well as by a method for the manufacture of an apparatus and a cover element in accordance with patent claim 14 or 15 and the use of a cover element in accordance with patent claim 16, as well as by a method for the additive manufacture of manufacturing products in accordance with claim 17.

In an apparatus in accordance with the invention for the additive manufacture of manufacturing products or components (hereinafter also more concisely termed “manufacturing apparatus”), by means of the selective consolidation of consecutive layers of a construction material which can be consolidated by irradiation, the desired manufacturing products or components are produced. In this regard, the consolidation takes place at positions which correspond to a cross section of the component in the respective layer. A preferred example in this regard is the aforementioned laser sintering apparatus, although the invention is not restricted thereto.

In this regard, the apparatus comprises at least one construction container with at least one height-adjustable construction platform. In this regard, the interior of the construction container and the construction platform define a construction space. In this regard, the opening of the construction container forms a construction area which is disposed above the construction platform. The construction area is located in the working plane, wherein the construction area is the region of the working plane in which the component is manufactured and wherein the construction area is disposed substantially congruently over the construction platform.

Furthermore, the apparatus comprises at least one consolidation device. Preferably, the consolidation device is a source of radiation, preferably a laser, for consolidation, i.e. preferably for irradiation, of the uppermost layer of the powdered construction material to be consolidated in the construction area of the current working plane (with a beam of energy). In this regard, the apparatus may—as is usual—have a beam deflection device (for example a scanner) for deflecting the beam of energy onto the respective layer to be consolidated, or in order to move the beam of energy in the desired manner over the current layer and to obtain the selective consolidation.

In this regard, the selective consolidation of the construction material may be carried out by means of electromagnetic radiation, in particular light radiation and/or thermal radiation. Alternatively, however, the construction material for consolidation may also be irradiated using beams of particles such as electron beams.

The apparatus also comprises at least one coater which, as already described above, is configured to apply layers of the construction material onto the construction platform and/or a previously applied layer, in order to bring the construction material into the current working plane with the construction area.

Finally, the apparatus also comprises at least one residual powder chamber. In this regard, the residual powder chamber is provided with at least one receiving opening in order to receive surplus powdered material which has been displaced by the coater. The receiving opening in this regard is configured in a manner such that, as already described above, the (surplus) powdered construction material displaced by the coater from the working plane in the direction of the residual powder chamber can be received by the residual powder chamber.

In accordance with the invention, the apparatus is configured in a manner such that a region between the construction area and the receiving opening has at least one device for enhibiting the flow of the powdered material. The “region between the construction area and the receiving opening” in this regard should be understood to mean a region which lies in the working plane or in the height of the working plane between the receiving opening concerned and the construction area, or the region between the construction platform and the receiving opening when the construction platform is located in the top position at the beginning of the construction process.

The term “flow inhibiting device” as used in the context of the invention should be understood to mean an apparatus which slows down or “inhibits” the flow of the powdered construction material. To this end, for example, a surface in a region between the construction area and the receiving opening may be modified and, for example, have coarser structures, whereupon the flowing movement of the powder on the surface is slowed down or completely stopped. Specific examples of how such a flow inhibiting device can be produced will be explained in more detail below.

Advantageously, then, with such a flow inhibiting device, the (residual) powder consumption during the additive manufacturing process can be significantly reduced. Up to now, the region between the construction area and receiving opening in commercially available manufacturing apparatuses have been equipped with a flat and relatively smooth surface orientated in the direction of the working plane. In this regard, this surface is so smooth that the powdered construction material can easily be displaced on this surface (for example during coating). In known systems, the roughness of these surfaces is given by an average roughness of Rₐ=0.4 μm. The average roughness Rₐ of a surface indicates the average distance of a measuring point on the surface to a specific centre line. The centre line intersects inside the reference length of the actual profile in a manner such that the sum of the deviations in the profile in a plane parallel to the centre line is divided over the length of the measured path. Put another way, the average roughness provides the arithmetic mean of the roughness profile.

By means of the flow inhibiting device in accordance with the invention, the region between the construction area and receiving opening is now specifically and deliberately configured in a manner such that at least in the region of the flow enhibiting barrier, the material cannot flow as easily in the direction of the residual powder chamber. The inventors have established that in this way, less powdered construction material (hereinafter also more concisely termed “powder”) is displaced into the at least one residual powder chamber, without the coating process per se being impaired thereby or without producing a more irregular coating. Because of the lower material consumption, large components can also be additively manufactured in a continuous process without having to empty the residual powder chamber. Thus, less residual powder has to be “recycled”, and the overall additive manufacturing process can become more cost-effective.

Preferably, the region between the construction area and the residual powder chamber and/or at least a portion of the residual powder chamber is covered by at least one cover element, leaving the receiving opening free, wherein the surface of the cover element has at least one flow inhibiting device for the powdered material. Particularly preferably, the receiving opening is in the form of an opening within the cover element.

Advantageously, a cover element of this type with a flow inhibiting device means that the flow inhibiting device can be produced in a simple manufacturing process on the flexible and easily handled cover element itself. In particular, manufacturing apparatuses which already exist can be retrofitted easily and inexpensively wherein, for example, existing cover elements (with smooth surfaces) can be replaced by cover elements with integrated flow inhibiting devices. As an alternative, the existing cover elements could also be retrospectively provided with a flow inhibiting device.

In a method in accordance with the invention for the manufacture of the aforementioned apparatus, a region between the construction area and the receiving opening is provided with at least one flow inhibiting device for the powdered material. Preferably in this method, the apparatus is provided with the cover element which will be described below.

A cover element in accordance with the invention for an apparatus as described above for the additive manufacture of manufacturing products is configured to cover a region between the construction area and the residual powder chamber and/or at least a portion of the residual powder chamber, leaving a receiving opening free. In this regard, the surface of the cover element has at least one flow inhibiting device for the powdered material.

In a preferred method in accordance with the invention for the manufacture of the cover element, the cover element is configured with at least one depression, wherein preferably, at least one insert plate is disposed in the depression. In addition, the cover element is provided with at least one flow inhibiting device for the powdered construction material. Preferably in this regard, only the insert plate is provided with a flow inhibiting device, because this means that the cover element can be manufactured in a particularly cost-effective manner. Because only the (smaller) insert plate has to be provided with a flow inhibiting barrier, the manufacturing process is therefore simpler and less costly.

Advantageously, a use in accordance with the invention of a cover element of this type in the manufacturing apparatus means that the powder consumption in the additive manufacturing process can be significantly reduced simply by using relatively cost-effective means (equipping the cover element with a flow enhibiting barrier), wherein the existing manufacturing apparatuses, as already mentioned above, can advantageously be retrofitted with such a cover element.

In the method in accordance with the invention for the additive manufacture of manufacturing products by the consecutive selective consolidation of layers, powdered construction material is consolidated by irradiation. The consolidated powdered construction material corresponds to a cross section of the manufacturing product. As mentioned above, the selective consolidation is carried out in an apparatus which comprises a construction container, a consolidation device (for example a source of radiation), a coater and a residual powder chamber. The construction container has at least one height-adjustable construction platform. The consolidation device serves for the consolidation of construction material to be consolidated on the construction platform. The coater applies layers of the construction material to the construction platform or to a previously applied layer. Displaced surplus powdered material can be received in the residual powder chamber through a receiving opening therein. In a region between the construction platform and the receiving opening, in accordance with the invention, a flow of the powdered material is mechanically inhibited by means of a flow inhibiting device.

Further, particularly advantageous embodiments and developments of the invention are defined in the dependent claims as well as in the description below, wherein the independent claims of one category of claims can be read onto the dependent claims and exemplary embodiments of another category of claims, and in particular, individual features of the various exemplary embodiments or variations may be combined to form new exemplary embodiments or variations.

Preferably, the flow inhibiting device of the manufacturing apparatus has a rough or roughened surface orientated in the direction of the working plane, or is formed thereby. The roughness is selected in a manner such that it is at least a factor of 2 higher than in a surrounding region. The surrounding region may be the cover element. The roughened surface is then only a sub-region of the cover element. However, the entire cover element may be provided with the rough surface. In this case, the construction platform may also be considered to be a portion of the “surrounding region” when a layer of the construction material has not yet been applied, or regions or strips to the side of the cover element and/or the construction platform.

The “roughness” of the surface between the construction area and the receiving opening orientated towards the working plane describes the unevenness of this surface here.

The exact configuration of the flow inhibiting device may advantageously also be selected as a function of the grain size of the currently used powdered construction material. As an example, surfaces with different surface roughnesses may be used as the flow inhibiting device, depending on the grain size of the particles of the powdered construction material. In this regard, a surface is rough in the context of this invention when the flowing movement of the currently used powder is inhibited during coating.

The surfaces of the customary prior art cover frame produced from stainless steel with a surface roughness of Rₐ=0.4 μm are considered to be “smooth” surfaces in the context of the invention, because powdered construction material “slides” or flows relatively unimpaired on such a surface.

Roughening of the surface may, for example, be carried out using jets of compressed air with a solid blasting medium (for example by means of sand blasting). The grains of sand in the jets of sand in this regard have a size which is preferably at least 50 μm and at most 500 μm. An example of a preferred blasting medium is corundum or garnet sand. In this case, blasting may preferably be carried out in a manner such that the surface roughness of the roughened surface, as explained above, is higher than the surrounding region by a factor of at least 2.

Alternatively or in a supplementary manner, the roughening of the surface may also be carried out with other mechanical methods such as milling, for example. If the roughening roughens the surface in a specific direction, then preferably, the direction in which the depressions or prominences caused by the roughening is transversely, particularly preferably substantially orthogonally, to the intended coating direction of the coater. This can ensure that the flow-inhibiting effect of the roughening is considerably more effective.

Naturally, the flow inhibiting device may also be envisaged as being formed by a suitable rough coating material. The coating material may also be a thin layer, such as a film or the like, which is applied to the surface, for example with adhesive. In a simple variation, for example, even crepe paper could be envisaged, which would be applied to a region between the construction area and the receiving opening.

It has surprisingly been shown that by means of a flow inhibiting device in the form of a roughened surface, the quantity of powder which is pushed unused into an over-flow can be reduced by up to 90%. Advantageously again, the roughening of a surface during the manufacturing process can be carried out relatively easily and in a cost-effective manner.

The flow inhibiting device in the form of a roughened surface may also comprise a specifically provided local accumulation of the powdered material. This means that it may potentially be sufficient to ensure that a very thin “base layer” of material (pos-sibly only one particle thick) which satisfies the desired requirements as regards roughness remains lying on the surface. The surface of this thin layer of powder may also be considered to be rough, to a certain extent.

This base layer of material providing the roughness of the surface may, for example, be retained on the surface with the aid of suitable bonding agents.

In order to ensure that the first layer remains in place, however, a very small obstacle may be sufficient, such as a small ridge, for example.

Preferably, then, the flow inhibiting device may also have at least one ridge.

In this regard, the ridge is formed on the surface of the cover element orientated in the direction of the working plane. The ridge may have multiple forms; preferably, however, the ridge is in the form of a ramp, nose, pyramid or a cuboid. The ridge may also have a concave or circular form. In optional embodiments, the ridge may preferably also be applied to the surface of the cover element. As an example, the ridge may be produced by an applied strip and/or bar. Particularly suitable materials for strips or bars of this type are those materials which have a smaller hardness than the coater, so that on contact with the coater, they do not damage it. Plastics in the form of strips or films are suitable examples in this regard.

As an alternative or in addition, the ridge may have a specific orientation with respect to the coating direction of the coater. In this regard, preferably, the ridge is transverse to, particularly preferably substantially orthogonal to the intended direction of coating of the coater. This ensures that the flow inhibiting effect of the ridge is considerably more effective.

Preferably, the height of the ridge is at least 0.1 mm, particularly preferably at least 0.5 mm and more particularly preferably at least 1 mm, as well as preferably a maximum of 50 mm, particularly preferably a maximum of 5 mm and more particularly preferably a maximum of 2 mm. In the values cited here, the height of the ridge is greater than the distance between the coater and the construction platform. This means that in the context of these values which are given, preferably, the travel of the coater is limited to just before the ridge at most. Conversely, if the travel of the coater extends over the ridge, then preferably, the height of the ridge is at most the same as the distance of the coater from the construction platform or the build platform, preferably at most ¾, particularly preferably at most half the distance of the coater from the construction platform or the build platform.

Advantageously, a ridge, like the roughened surface of the cover element described above, reduces the flowing movement of the powdered construction material. This means that less residual powder, which has to be “recycled” or disposed of at great expense, falls into the residual powder chambers. In addition, the ridge can advantageously be applied between the construction platform and the receiving opening using very simple means. The application of the ridge can therefore, for example, also be particularly easily carried out during “retrofitting” of the apparatus for the additive manufacture of manufacturing products.

Particularly preferably, the flow inhibiting device and in particular the ridge is configured directly on or at a short distance, preferably a maximum of 50 mm and preferably a maximum of 20 mm, particularly preferably a maximum of 5 mm, from the receiving opening. This in particular solves the problem of the travel of the coater being unnecessarily limited by the positioning of the ridge.

As an example, the flow inhibiting device may have both a roughened surface as well as a ridge, wherein preferably, the roughened surface orientated in the direction of the working plane is formed shortly before the receiving opening and the ridge is at the receiving opening. Naturally, it is also possible for the flow inhibiting device to comprise only the roughened surface or only the ridge.

Advantageously, the application of the flow inhibiting device in front of the receiving opening means that the flowing movement of the powdered construction material on the working plane is only inhibited or significantly reduced in the immediate proximity of the residual powder chambers, while the flow behaviour of the powder on the construction area is not limited. In this manner, the coater can rapidly and efficiently apply an even layer of the construction material to the construction area.

As already mentioned, the manufacturing apparatus preferably has at least one cover element. Particularly preferably, the cover element here has the flow inhibiting device, wherein more particularly preferably, the flow inhibiting device is produced by a roughened surface and/or a ridge. This means that as already mentioned, a manufacturing apparatus can be particularly easily retrofitted with a flow inhibiting device in which, for example, a cover element without a flow inhibiting device, is simply replaced by a cover element with a flow inhibiting device.

Particularly preferably in this regard, the cover element has a cover frame, wherein the cover frame has at least one opening which forms the receiving opening, in order to feed the surplus powdered material displaced by the coater to the residual powder chamber.

Advantageously, a cover element, which is preferably in the form of a cover frame, can be manufactured in a particularly simple and cost-effective manner and in operation can be disposed in a stable manner in the processing area in a region between the construction area and the receiving opening of the manufacturing apparatus.

Preferably, at least one depression is formed in a region between the construction platform and the receiving opening, and particularly preferably in the cover element itself.

More particularly preferably, at least one insert plate is disposed in this depression, wherein the depression and the insert plate are configured in a manner such that the surfaces orientated towards the working plane or lying in a working plane are substantially aligned at a transition of the surface of the cover element to the surface of the insert plate. In this manner, the insert plate forms a substantially flat, even surface around the surrounding region or with the cover element.

Advantageously, such an aligned or exact disposition of the insert plate means that finely powdered construction material does not unintentionally collect in depressions or gaps which would otherwise be formed in the regions of the outer edges of the insert plate.

Preferably, the insert plate described above has the flow inhibiting device and particularly preferably, viewed in the direction of the construction area or from the construction area, it is attached directly in front of the receiving opening (below the working plane). Alternatively, the insert plate may also form the receiving opening in the form of an opening.

Advantageously, a flow inhibiting device can be manufactured in a particularly prac-tical and cost-effective manner by means of such an insert plate. This is because it is sufficient, for example, for only the insert plate—as a relatively small or compact and readily worked single piece—to have to be provided with a flow inhibiting device.

The invention will now be described again in more detail with reference to the accompanying figures and with the aid of exemplary embodiments. In this regard, in the various figures, identical components are provided with identical reference numerals. The figures are generally not to scale. In the highly diagrammatic figures:

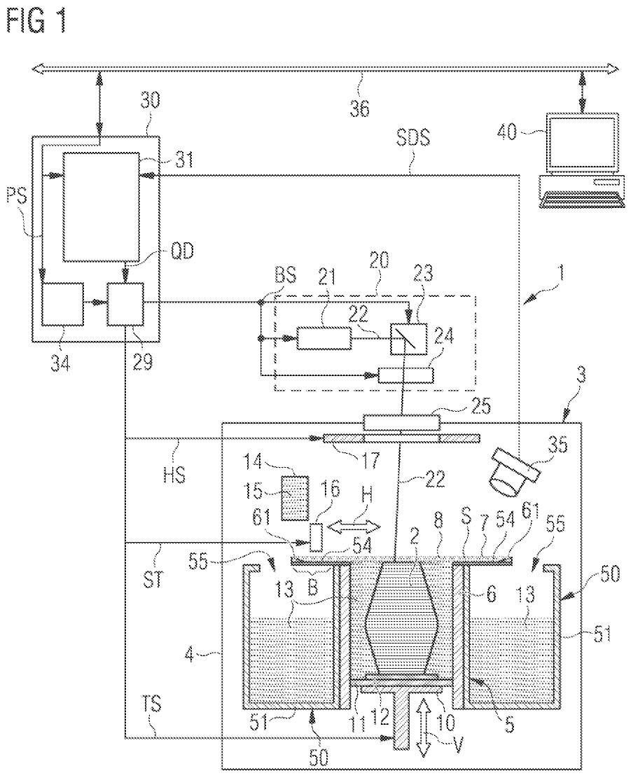

FIG. 1 shows a partially sectional view of an exemplary embodiment of an apparatus in accordance with the invention for the additive manufacture of manufacturing products,

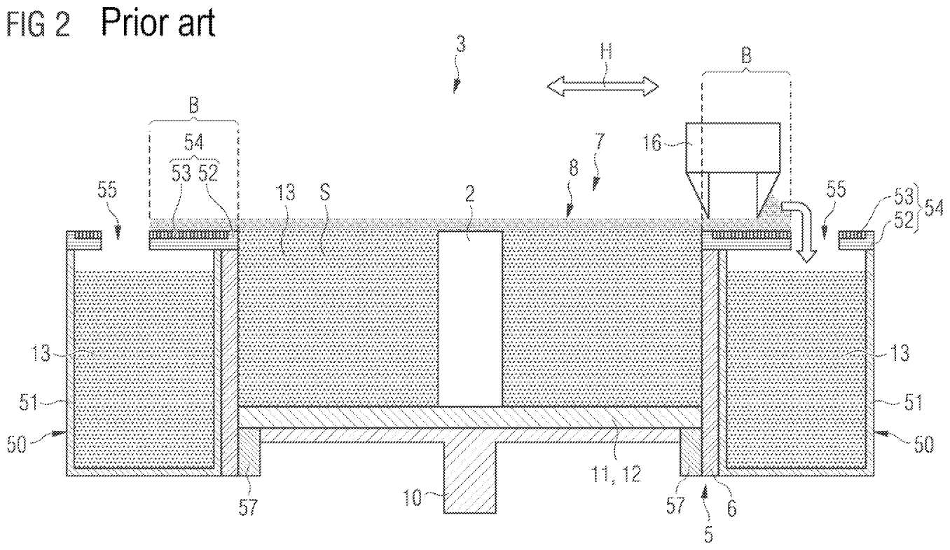

FIG. 2 shows a sectional view of an exemplary embodiment of a processing area of an apparatus for the additive manufacture of a manufacturing product without a flow inhibiting device, in accordance with the prior art,

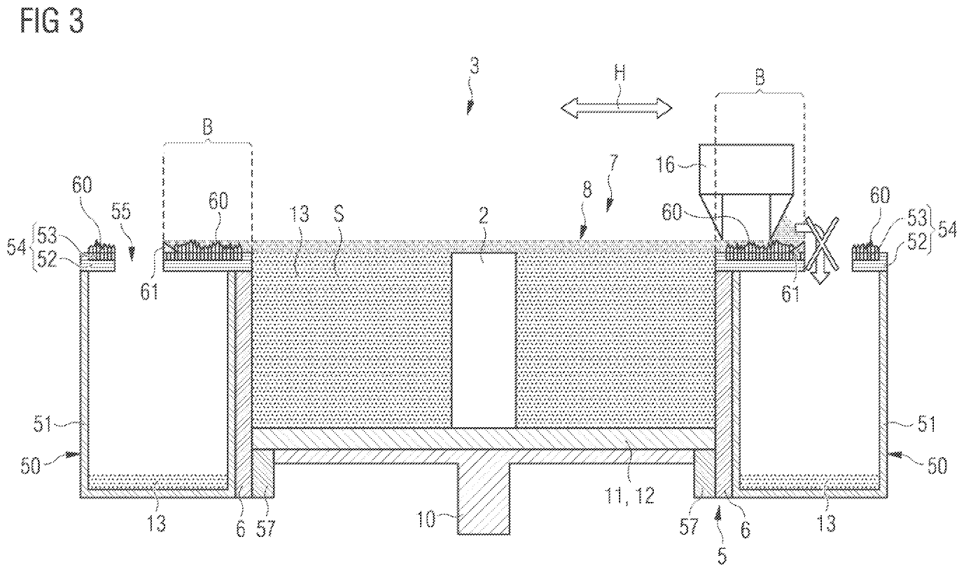

FIG. 3 shows a sectional view of an exemplary embodiment of a processing area of a device in accordance with the invention for the additive manufacture of a manufacturing product, with a flow inhibiting device,

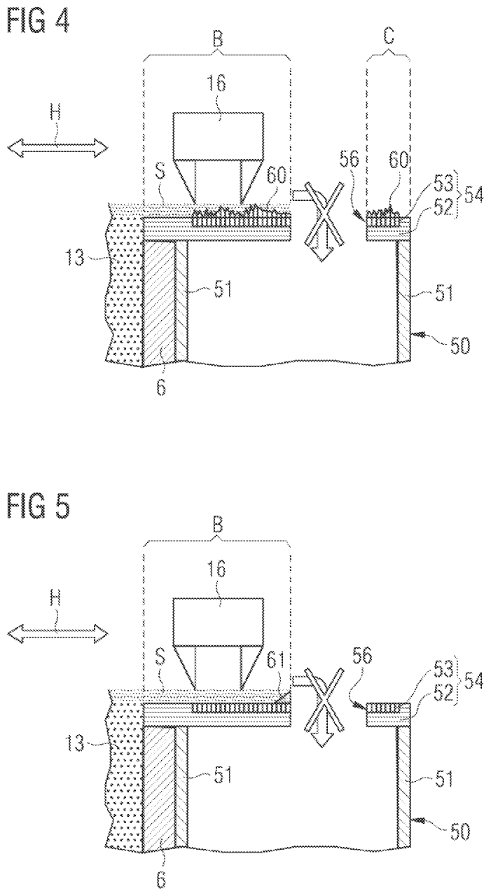

FIG. 4 shows a detailed sectional view of an exemplary embodiment of a cover frame with a roughened surface as a flow inhibiting device,

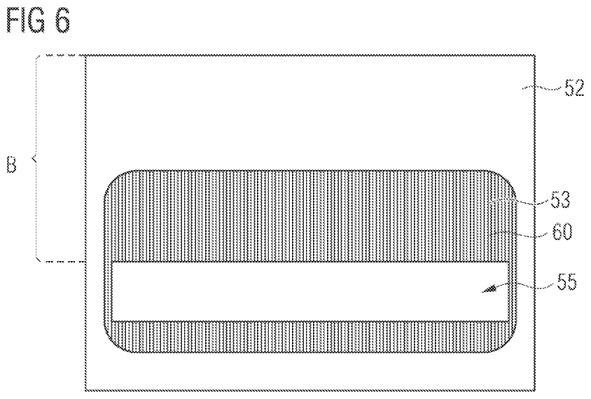

FIG. 5 shows a detailed sectional view of a further exemplary embodiment of a cover frame with a ridge as a flow inhibiting device,

FIG. 6 shows a top view of an exemplary embodiment of a cover frame with an insert plate with a roughened surface.

The exemplary embodiments below are described with reference to an apparatus 1 for the additive manufacture of manufacturing products 2 (hereinafter also termed objects 2) in the form of a laser sintering or laser melting apparatus 1, wherein it is explicitly indicated that the invention is not limited to laser sintering apparatus or laser melting apparatus. The apparatus 1 will therefore hereinafter—but in a non-limiting manner—be more concisely described as a “laser sintering apparatus 1”

A laser sintering apparatus 1 of this type is diagrammatically shown in FIG. 1. The apparatus has a processing area 3 or a processing chamber 3 with a chamber wall 4, in which the manufacturing process is substantially carried out. A construction container 5 which is open at the top and has a container wall 6 is located in the processing chamber 3. The upper opening of the container 5 forms the respective current working plane 7. The region of this working plane 7 which lies inside the opening of the container 5 is described as the construction area 8 or the construction space 8 and may be used to construct the object 2.

During the construction process, firstly, the construction material 15 from a storage container 14 is applied to the working plane 7 by a coater 16. The coater 16 is then displaced in the working plane 7 at a prespecified height so that the layer S of the powdered construction material 13 located on the working plane 7 lies at a defined height over the last consolidated layer.

The container 5 has a base plate 11 which can move in a vertical direction V and which is disposed on a support 10. The base plate 11 closes the base of the container 5 at the bottom and therefore forms its base. The base plate 11 may be formed inte-grally with the support 10, but it may also be a plate which is separate from the support 10 and be attached to the support 10, or simply be placed on it. A construction platform 12, or more concisely a build platform 12, may be mounted on the base plate 11 as a build substrate, on which the object 2 is constructed. In principle, however, the object 2 may also be constructed on the base plate 11 itself, which then itself forms the build substrate or the construction platform 12, or more concisely, the build platform 12 (as can be seen in FIGS. 2 and 3, for example).

In principle, the object 2 is constructed by initially applying a layer S of construction material 13 to the build platform 12, and then—as will be explained below—the construction material 13 is selectively consolidated with a source of radiation, specifically here a laser, 21, at positions which are intended to form parts of the object 2 to be manufactured, then with the aid of the support 10, the base plate 11, and therefore the build platform 12, is dropped by one layer thickness and a new layer S of the construction material 15 is applied and then selectively consolidated, and so on. As mentioned above, the invention is not limited to laser sintering apparatus/laser melting apparatus. Thus, although not always explicitly indicated below, the laser 21 may also be a consolidation device of a different type. The object 2 shown in each of FIGS. 1 to 3 is below the working plane 7 in an intermediate state. The object 2 is surrounded by construction material 13 which remains unconsolidated. Different electrically conducting powders may be employed as the construction material 15. The use of metallic construction materials as well as self-conducting or intrinsically conductive plastics, and also those plastics which gain an electrical conductivity by adding electrically conductive fillers, is preferred.

Fresh construction material 15 is located in a storage container 14 of the laser sintering apparatus 1. As mentioned, the construction material 15 can be applied to the working plane 7 in the form of a thin layer S with the aid of a coater 16 which can be moved in a horizontal direction H.

Optionally, a radiant heater 17 may be located in the processing chamber 3. This may be used to heat the freshly applied construction material 13, wherein in principle, the construction material 13 in the entire construction area 8 is heated. The quantity of basic energy introduced into the construction material 13 by the heating apparatus 17 is below the energy necessary to sinter or even to melt the construction material 13.

For selective consolidation, the laser sintering apparatus 1 has a consolidation device 20 which here is in the form of an irradiation device 20 with a laser 21. The laser 21 produces a laser beam 22 which is deflected via a deflection device 23 (scanner 23) in order to selectively introduce energy into the respective regions of the layer S to be selectively consolidated in accordance with a prespecified irradiation strategy. Furthermore, this laser beam 22 is focussed by a focussing device 24 onto the working plane 7 in a suitable manner. Here, the irradiation device 20 is preferably located outside the processing chamber 3 and the laser beam 22 is guided into the processing chamber 3 via a coupling window 25 in the chamber wall 4 which is attached to the top of the processing chamber 3 and impinges at a specific position on the working plane 7, i.e. the current layer S to be consolidated.

As an example, the consolidation device 20 may comprise not just one, but a plurality of lasers 21. Preferably in this regard, it may be a gas or solid state laser or any other type of laser such as, for example, laser diodes, in particular VCSEL (Vertical Cavity Surface Emitting Laser) or VECSEL (Vertical External Cavity Surface Emitting Laser), or a line of these lasers.

In addition, the laser sintering apparatus 1 comprises a control device 30 which can be operated by means of a terminal 40. The control device 30 may have a plurality of interfaces (not shown) which will be described below and, for example, may also receive and process information from a sensor assembly 35 in the processing chamber 3.

Here, the control device 30 comprises a processing module 34, which computes or optimizes an irradiation strategy for the layer-by-layer manufacture of the additive component. Process control data PS (for example 3D construction data), which comprises at least the corresponding control data for the selective consolidation of the individual layers of the component, may serve as the input parameters.

The laser sintering apparatus 1 further (optionally, also below) contains a sensor assembly 35 which is suitable for detecting process radiation emitted when the laser beam 22 impinges on the construction material 13 in the working plane 7. In this regard, this sensor assembly 35 operates in a spatially resolved manner, i.e. it is capable of acquiring a kind of emissive image of the respective layer. Preferably, the sensor assembly 35 used is an imaging sensor or a camera which is sufficiently sen-sitive in the range of the emitted radiation. Alternatively or in addition, one or more sensors for detecting optical and/or thermal process radiation may be used, for example photodiodes, which detect the electromagnetic radiation emitted by a melt pool under the laser beam 22, or a temperature sensor for detecting emitted thermal radiation. The signals detected by the sensor assembly 35 are transferred to a control device 30 of the laser sintering apparatus 1 as a processing area sensor data set SDS, which also serves to control the various components of the laser sintering apparatus 1 for overall control of the additive manufacturing process.

The control device 30 is constructed in a manner such that the laser sintering apparatus 1, in particular the irradiation device 20, is controlled by means of a control unit 29 in accordance with the irradiation strategy which has previously been computed or optimized by means of the processing module 34. To this end, the control unit 29 controls the components of the irradiation device 20, namely in this case the laser 21, the deflection device 23 and the focussing device 24, in the usual manner and transfers the appropriate irradiation control data BS. The control unit 29 also controls the radiant heater 17 by means of suitable heating control data HS, the coater 16 by means of coating control data ST and the movement of the support 10 by means of support control data TS.

Optionally, the control device 30 may comprise a further control device 31 which determines quality data QD using process control data PS and the processing area sensor data set SDS or other suitable process data which, for example in a variation, may be transferred to the control unit 29 in order to be taken into consideration when managing the irradiation strategy and therefore to be able to intervene in the additive manufacturing process.

The control device 30 here is coupled to the terminal 40 with a display or the like, for example via a bus 36 or another data link. An operator can control the control device 30 via the terminal 40 and therefore control the entire laser sintering apparatus 1. In particular, the display of the terminal 40 may also be used as the manufacturing process is running, in order to visualise the irradiation strategy for the manufacture of the component 2 and/or the processing area sensor data set SDS and/or the quality data QD.

After consolidation of the construction material 13, superfluous, non-consolidated construction material 13 remains on the construction area. This non-consolidated construction material 13 is displaced by the coater 16 into a residual powder chamber 50. Two residual powder chambers 50 are located to the left and right of the container wall 6. The residual powder chambers 50 are covered by a cover element 54. A receiving opening 55 is located in the cover element 54 so that non-consolidated construction material 13 can be displaced into the residual powder chambers 50.

It will be indicated once again at this juncture that the present invention is not limited to a laser sintering apparatus 1 as shown in FIG. 1 by way of example. It can be used for any other apparatus for the generative or additive manufacture of a three-dimensional object, in particular by layer-by-layer application and selective consolidation of a construction material. Correspondingly, a cover element 54 provided with a flow inhibiting device 61 may also be used in any comparable equipment.

In the exemplary embodiment represented in FIG. 1, a flow inhibiting barrier 61 is located in a region B between the construction area 8 and the respective receiving openings 55 of the residual powder chambers 50, 51, the flow inhibiting barrier here being in the form of a ridge 61 or strip which is disposed directly in front of the receiving opening 55 and which extends slightly upwards from the working plane. In this figure, the representation of the size of the ridge 61 is exaggerated; in reality, a very small ridge is sufficient to prevent, for example, a first thin layer of powder at the ridge from immediately sliding into the receiving opening 55. Possible embodiments of such flow inhibiting barriers 60, 61 will be described in more detail below with the aid of FIGS. 3 to 6.

In order to illustrate the problem which is solved by the invention, however, firstly, a rough diagrammatic representation of an exemplary embodiment of a processing area of an apparatus for the additive manufacture of a manufacturing product from the prior art, and therefore without a flow inhibiting device in accordance with the invention, will be described in FIG. 2.

In the example of manufacturing apparatus 1 of the prior art shown in FIG. 2—as is standard practice (see also FIG. 1, the only difference between that and FIG. 2 being the flow inhibiting barrier 61)—two residual powder chambers 50, each with a residual powder chamber wall 51, are located laterally adjacent to the construction container 5 in a displacement direction of the coater 16 (which corresponds to the horizontal direction H), in order to receive the powder 13 displaced by the coater 16 over the construction area 8 and the working area 7 and to collect this powder in one of the residual powder chambers 50 as residual powder 13. The residual powder chambers 50 are each covered by a cover frame 54 which, however, has an opening 55 for receiving the residual powder 13.

As stated above, the apparatus 1 from the prior art of FIG. 2 does not have a flow inhibiting device. Consequently and as mentioned above, the surface of the cover element 54 in the region B between the construction platform 12 and the receiving opening 55 has a flat and smooth surface on which the powdered construction material 13 can naturally slide or be displaced very easily because the smooth substrate barely inhibits its flowing movement. Thus, during coating, a very large amount of powdered construction material 13 is displaced from the working plane 7 into the residual powder chambers 50 (represented here by an arrow) and has to be recycled at great expense as residual powder 13.

The laser sintering apparatuses 1 shown in FIGS. 3 to 6 or the sections of the apparatuses 1 now show detailed views of the laser sintering apparatuses 1 in accordance with the invention. The exemplary embodiments shown each have flow inhibiting devices 60, 61 which have been produced in the form of a roughened surface 60 and/or as a ridge 61. In this regard, FIG. 3 shows a flow inhibiting device 60, 61 in accordance with the invention which is configured in the form of a roughened surface 60 and additionally a respective ridge 61. FIG. 4 shows a diagrammatic detailed view of a flow inhibiting device 60 configured as a roughened surface 60. FIG. 5 shows a diagrammatic detailed view of a flow inhibiting device 61 configured as a ridge 61 and FIG. 6 shows a top view of a cover frame 54 with an insert plate 53. In this regard, the insert plate 53 has the flow inhibiting device 60 in the form of a roughened surface 60.

The laser sintering apparatus 1 shown in FIGS. 2 to 6 each have two cover frames 54, each of which being disposed on the outer boundaries of the build platform 12 over the construction container wall 6 and the residual powder chambers 50. The cover frame 54 here comprises a larger plate 52 and a smaller plate 53, wherein the larger plate 52 sits on the residual powder chamber 50 and on the container wall 6 of the construction container 5, in order to span or cover a gap between the construction container 5 and the residual powder chamber 50.

The smaller plate 53 (hereinafter also termed the insert plate 53) is substantially exactly inserted in a recess 56 of the larger plate. This means that the insert plate 53 together with the larger plate 52 forms a substantially flat area and the insert plate 53 is flush with the surface of the larger plate 53 in the recess 56 of the larger plate 52 (in this regard, see FIG. 4, for example).

In addition, the cover frame 54 has an opening 55 through which powder displaced from the working area 7 can be caught in the residual powder chamber 50 (in this regard, see also FIG. 6). In this exemplary embodiment, the opening 55 is pro-duced by a recess inside the larger plate 52 and the insert plate 53. Ideally—as can be seen in FIGS. 2 to 5—the recesses of both plates 52, 53 are congruent recesses which together form the opening 55 of the cover frame 54.

In this exemplary embodiment, the surface of the cover frame 54 of the laser sintering apparatus 1 has a flow inhibiting barrier 60, 61 in order to at least reduce a displacement of powder 13 into the residual powder chambers 50.

Thus, for example, simply roughening the surface 60 of the insert plate 53 of the cover frame 54 leads to a significant reduction in the flow of powder 13 into the residual powder chambers 50, or the powder can no longer be displaced as easily (FIGS. 3, 4 and 6).

FIGS. 3, 4 and 6 show an exemplary embodiment of a cover frame 54 with an insert plate 53 with the flow inhibiting device 60 in the form of a roughened surface 60. As can be seen in FIG. 4, for example, the entire upwardly orientated surface of the insert plate 53 is roughened—also in a region C behind the receiving opening 55 (in this regard, see FIG. 4). Naturally, the insert plate may also be roughened in only the region B between the construction container 5 and the receiving opening 55, but a fully roughened surface of the insert plate 53 can facilitate the process for manufacturing an insert plate 53 with the roughened surface 60 simply, because in this case only the easy and readily handlable insert plate 53 has to be roughened—for example by sand blasting.

In a further embodiment, it is also possible to envisage the flow inhibiting barrier 61 being produced by a kind of ridge 61, as shown in FIGS. 1, 3 and 5, enlarged for illustration purposes. This ridge 61 may already have been integrated during the manufacturing process into a plate 52, 53 of the cover frame 54 which is located under the working area 7 during operation. However, it is also possible to envisage a ridge 61 of this type being applied to or mounted on the cover frame 54 following the manufacturing process, for example when retrofitting the laser sintering apparatus 1.

In each case, the consumption of powder when using the flow inhibiting device 60, 61 in accordance with the invention falls, so that only a little residual powder 13 drops into the residual powder chambers 50 (FIGS. 3 and 5). Advantageously, then, the apparatus 1 in accordance with the invention with a flow inhibiting device 60, 61 results in a substantially less expensive and less complicated process for the additive manufacture of manufactured products 2, because far less residual powder 13 has to be recycled and more powder 13 can be processed directly during the manufacturing process.

Finally, it should be indicated once again that the above detailed description of the apparatus 1 concerns additive manufacture, and the described flow inhibiting devices 60, 61 are only exemplary embodiments which could be modified by the person skilled in the art in very different ways without departing from the scope of the invention. Thus, for example, the flow inhibiting devices 60, 61 shown in the respective exemplary embodiments can be exchanged and/or combined in any manner. As an alternative or in addition in this regard, the residual powder chambers 50 may be covered with other cover elements 54 which are suitable but which have not been described in the above exemplary embodiments. Furthermore, the use of the indefi-nite article “a” or “an” does not exclude the fact that the features concerned could also be present in multiples.

### LIST OF REFERENCE NUMERALS

1 apparatus for additive manufacturing/laser sintering apparatus
2 manufactured product/object
3 processing area/processing chamber
4 chamber wall
5 construction container/interchangeable frame
6 container wall
7 working plane
8 construction area
10 support
11 base plate
12 construction platform
13 residual powder
14 storage container
15 construction material
16 coater
17 radiant heater
20 consolidation device/irradiation device/illumination device
21 source of radiation/laser
22 laser beam
23 deflection device
24 focussing device
25 coupling window
29 control unit
30 control device
31 control device
34 computing module
35 sensor assembly/camera
36 bus
40 terminal
50 residual powder chamber
51 residual powder chamber wall
52 large plate
53 insert plate
54 cover element
55 opening in cover element
56 depression in cover element
57 edge of base
60 flow inhibiting device/rough surface
61 flow inhibiting device/ridge
B region of cover element between construction platform and receiving opening
C region of cover element behind the receiving opening
V vertical direction
H horizontal direction
BS irradiation control data
HS heating control data
PS process control data
QD quality data
S layers of powdered construction material to be consolidated
ST coating control data
TS support control data
SDS processing area sensor data

1. An apparatus for the additive manufacture of manufacturing products by consecutive selective consolidation of layers of a powdered construction material which can be consolidated at positions which correspond to a cross section of the manufacturing product, having:
at least one construction container comprising at least one height-adjustable construction platform,
at least one consolidation device for consolidating construction material to be consolidated in a construction area above the construction platform,
at least one coater, wherein the coater is configured to apply layers of the construction material to the construction platform and/or to a previously applied layer,
and
at least one residual powder chamber with a receiving opening for receiving surplus powdered material displaced by the coater,
wherein a region between the construction area and the receiving opening has at least one flow inhibiting device for the powdered material.

2. The apparatus as claimed in claim 1, wherein a region between the construction area and the residual powder chamber and/or at least a portion of the residual powder chamber is covered by at least one cover element, leaving the receiving opening free, and the surface of the cover element has at least one flow inhibiting device for the powdered material.

3. The apparatus as claimed in claim 1, wherein a roughness of the flow inhibiting device is higher than that of a surround of the flow inhibiting device by a factor of at least 2.

4. The apparatus as claimed in claim 3, wherein the flow inhibiting device comprises a specifically provided local accumulation of the powdered construction material.

5. The apparatus as claimed in claim 1, wherein the flow inhibiting device has at least one ridge.

6. The apparatus as claimed in claim 5, wherein the ridge, is formed directly on and/or at a short distance from the receiving opening.

7. The apparatus as claimed in claim 5, wherein a height of the ridge is at least 0.1 mm, and/or at most 50 mm,
and/or
wherein a height of the ridge is at most equal to a distance between the coater and the construction platform.

8. The apparatus as claimed in claim 2, wherein the cover element has a cover frame, wherein the cover frame has an opening which forms the receiving opening.

9. The apparatus as claimed in claim 1, wherein at least one depression is disposed in a region between the construction area and the receiving opening.

10. The apparatus as claimed in claim 9, wherein at least one insert plate is disposed in the depression, and the insert plate.

11. The apparatus as claimed in claim 10, wherein the depression and the insert plate are configured in a manner such that the surface orientated towards a working plane or lying in a working plane are substantially aligned at a transition to the insert plate.

12. The apparatus as claimed in claim 10, wherein the insert plate having the flow inhibiting device is disposed in front of the receiving opening in the intended coating direction of the coater, or comprising the receiving opening in the shape of an opening.

13. A cover element for an apparatus for the additive manufacture of manufacturing products as claimed in claim 1,
wherein the cover element is configured to cover a region between the construction area and the residual powder chamber and/or at least a portion of the residual powder chamber, leaving a receiving opening free,
wherein the surface of the cover element has at least one flow inhibiting device for the powdered material.

14. A method for the manufacture of an apparatus as claimed in claim 1, wherein a region between the construction area and the receiving opening is provided with at least one flow inhibiting device for the powdered material.

15. A method for the manufacture of a cover element as claimed in claim 13, wherein the cover element is configured with at least one depression and at least one insert plate is disposed in the depression, wherein the insert plate is provided with at least one flow inhibiting device for the powdered construction material.

16. Use of a cover element as claimed in claim 13, for an apparatus.

17. A method for the additive manufacture of manufacturing products by consecutive selective consolidation of layers of a powdered construction material which can be consolidated at positions which correspond to a cross section of the manufacturing product, in an apparatus having:
at least one construction container comprising at least one height-adjustable construction platform,
at least one consolidation device for consolidating construction material to be consolidated on the construction platform,
at least one coater, wherein the coater is configured to apply layers of the construction material to the construction platform or to a previously applied layer,
and
at least one residual powder chamber with a receiving opening for receiving surplus powdered material displaced by the coater,
wherein a flow of the powdered material is inhibited in a region between the construction platform and the receiving opening.
